(19) United States
(12) Patent Application Publication
(10) Pub. No.: US 2026/0308064 A1
(43) Pub. Date: Oct. 8, 2026

(54) SMART CONSTRUCTION MATERIALS FOR AMBIENT MODIFICATION OF BUILT ENVIRONMENTS

(71) Applicant: Texas State University, San Marcos, TX (US)

(72) Inventor: Wilson F. Espinoza, San Marcos, TX (US)

(21) Appl. No.: 19/638,521

(22) Filed: Apr. 3, 2026

Related U.S. Application Data
(60) Provisional application No. 63/783,068, filed on Apr. 3, 2025.

(51) Int. Cl. C04B 28/04; C04B 14/06; C04B 14/18; C04B 14/20; C04B 24/38; C04B 103/00; C04B 103/32; C04B 103/54; C04B 111/00; C04B 111/52; C04B 111/80

(52) U.S. Cl. CPC C04B 28/04; C04B 14/06; C04B 14/185; C04B 14/202; C04B 24/38; C04B 2103/0071; C04B 2103/32; C04B 2103/54; C04B 2111/00019; C04B 2111/52; C04B 2111/807; C04B 2201/50

(57) ABSTRACT

A smart construction material, structural element and method for improving the physical and psychological well-being of occupants through thermally-enhanced and extra-sensory additive integration. The construction material includes a cementitious matrix with a distributed network of bioinspired additives, including at least one thermally-active component and at least one sensory-active component. The thermally-active component provides an increased specific heat capacity and at least a 15% reduction in thermal conductivity compared to a standard mortar. The sensory-active component is configured to provide extra-sensory features, such as bioluminescence or color adaptation, to mitigate psychological distress in a built environment. The structural element maintains a compressive strength of approximately 25 MPa or greater. The manufacturing method includes preparing a dry mix of binder and aggregate, incorporating the bioinspired additives at a controlled shear speed to prevent mechanical rupture, and adding a liquid activator to form a wet mortar for curing.

### TECHNICAL FIELD

The present disclosure relates generally to the field of civil engineering and construction materials, and more particularly to smart construction materials, such as mortar and concrete, configured for the ambient modification of built environments to improve the physical and psychological well-being of occupants through thermally-enhanced and extra-sensory additive integration.

### BACKGROUND

The fields of civil engineering and construction materials have historically focused on the development of structural components designed to ensure the safety, resilience, and longevity of the built environment. Traditionally, the selection and engineering of materials, such as concrete, mortar, and steel, have been driven by mechanical requirements, such as load-bearing capacity and environmental durability. While these criteria are essential for structural integrity, there is a growing recognition that the materials used in urban infrastructure also serve as a critical interface between the environment and human biology. Consequently, modern engineering must expand its scope beyond structural utility to consider how material properties directly influence the physiological and psychological experiences of those within the spaces they create.

In this context, the built environment plays a fundamental role in human health and well-being. Modern residential and urban infrastructure, however, often faces significant challenges that contribute to physical and psychological distress. Poor-quality housing and urban density are increasingly recognized as contributing factors to mental health discomfort, exacerbated by environmental stressors, such as extreme weather conditions, high air pollution, and noise. Traditional construction materials, such as standard concrete and mortar, are often limited in their ability to mitigate these factors, typically offering only basic structural integrity without addressing the sensory or thermal needs of the occupants.

Existing construction technologies have primarily focused on mechanical performance, such as compressive strength and durability, rather than the “ambient modification” of living spaces. For example, standard mortar samples (S0) provide necessary structural support but do not inherently regulate temperature or acoustics to a degree that improves mental wellness. Furthermore, the construction industry faces a sustainability crisis, characterized by high carbon emissions and the underutilization of waste materials, which further complicates the development of affordable, high-quality housing.

While some thermally-enhanced materials exist, they often suffer from high costs or a lack of “extra-sensory” features, such as sound absorption, bioluminescence, and color adaptation, that are essential for bioinspired engineering. Moreover, many additives intended to improve material properties can significantly reduce the compressive strength of the resulting mortar, making them unsuitable for structural use. Consequently, there is a need for a new class of smart construction materials that can improve the physical and mental comfort of building occupants while maintaining structural standards and minimizing the carbon footprint of the built environment. Such a system would ideally integrate waste-sequestration techniques with thermally and sensory-enhanced additives to create “smart spaces” that proactively counter mental health discomfort.

### SUMMARY

In one embodiment of the present disclosure, a smart construction material for ambient modification of a built environment comprises a base mortar mixture comprising a binder and an aggregate. The smart construction material further comprises a plurality of bioinspired additives integrated into the base mortar mixture, where the plurality of bioinspired additives comprises a thermal-regulation additive and a sensory-enhancement additive, and where the smart construction material is configured to maintain a compressive strength of approximately 25 MPa while providing a reduction in thermal conductivity compared to a standard mortar mixture.

In another embodiment of the present disclosure, a method for manufacturing a smart construction material comprises preparing a dry mix of a binder and an aggregate. The method further comprises incorporating a plurality of bioinspired additives into the dry mix, where the bioinspired additives include a thermally-active component and a sensory-active component. The method additionally comprises adding a liquid activator to the dry mix to form a wet mortar. Furthermore, the method comprises curing the wet mortar to form a structural component, where the structural component is characterized by a compressive strength exceeding 3000 psi.

In a further embodiment of the present disclosure, a structural element for use in a health-responsive built environment, the structural element comprises a cured cementitious matrix and a distributed network of smart additives within the cured cementitious matrix. The smart additives comprise a thermal barrier additive configured to increase a thermal resistance (R-value) of the structural element and a bio-mimetic additive configured to improve an acoustic damping of the structural element.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a smart construction material shown in a cured, cross-sectional state;

FIG. 2 provides a graphical representation of the mechanical and thermal performance characteristics of the smart construction material across a plurality of samples (S0, S1, S2, S3, S4) in accordance with an embodiment of the present disclosure;

FIG. 3 illustrates a perspective view of a structural element containing the smart construction material of FIG. 1 in accordance with an embodiment of the present disclosure;

FIG. 4 is a flowchart of a method for producing the smart construction material in accordance with an embodiment of the present disclosure;

FIG. 5 illustrates the compressive strength (MPa) versus mortar samples with additives in accordance with an embodiment of the present disclosure;

FIG. 6 illustrates the specific heat capacity versus additive percentage in accordance with an embodiment of the present disclosure;

FIG. 7 illustrates the compressive strength versus waste percentage in accordance with an embodiment of the present disclosure;

FIG. 8 illustrates workability and flow metrics in accordance with an embodiment of the present disclosure; and

FIGS. 9A-9B provide a side-by-side comparison of an optical picture and a thermal picture of the smart construction material in a real-world field pilot application, respectively, in accordance with an embodiment of the present disclosure.

### DETAILED DESCRIPTION

As stated above, the built environment plays a fundamental role in human health and well-being. Modern residential and urban infrastructure, however, often faces significant challenges that contribute to physical and psychological distress. Poor-quality housing and urban density are increasingly recognized as contributing factors to mental health discomfort, exacerbated by environmental stressors, such as extreme weather conditions, high air pollution, and noise. Traditional construction materials, such as standard concrete and mortar, are often limited in their ability to mitigate these factors, typically offering only basic structural integrity without addressing the sensory or thermal needs of the occupants.

Existing construction technologies have primarily focused on mechanical performance, such as compressive strength and durability, rather than the “ambient modification” of living spaces. For example, standard mortar samples (S0) provide necessary structural support but do not inherently regulate temperature or acoustics to a degree that improves mental wellness. Furthermore, the construction industry faces a sustainability crisis, characterized by high carbon emissions and the underutilization of waste materials, which further complicates the development of affordable, high-quality housing.

While some thermally-enhanced materials exist, they often suffer from high costs or a lack of “extra-sensory” features, such as sound absorption, bioluminescence, and color adaptation, that are essential for bioinspired engineering. Moreover, many additives intended to improve material properties can significantly reduce the compressive strength of the resulting mortar, making them unsuitable for structural use. Consequently, there is a need for a new class of smart construction materials that can improve the physical and mental comfort of building occupants while maintaining structural standards and minimizing the carbon footprint of the built environment. Such a system would ideally integrate waste-sequestration techniques with thermally and sensory-enhanced additives to create “smart spaces” that proactively counter mental health discomfort.

The embodiments of the present disclosure provide a means for developing a new class of smart construction materials that can improve the physical and mental comfort of building occupants while maintaining structural standards and minimizing the carbon footprint of the built environment. In particular, embodiments of the present disclosure relate to a smart construction material that utilizes a multi-functional additive system integrated within a cementitious matrix. Unlike traditional materials that prioritize mechanical strength at the expense of environmental interaction, embodiments of the present disclosure leverage bioinspired engineering principles to imbue structural components with proactive ambient-modification capabilities. By selectively incorporating thermal-regulation additives alongside sensory-enhancement components, the resulting material functions as a biological-environmental interface, actively regulating temperature and providing sensory feedback while meeting or exceeding the load-bearing requirements of civil engineering standards. While the smart construction material is described herein as maintaining a compressive strength of at least 25 MPa to satisfy specific structural requirements, it will be understood that the strength threshold may be adjusted, for example, to approximately 25 MPa or lower, to fit and exceed the strength requirements of various standard mortar mixtures across structural and non-structural applications.

The integration of these additives is carefully balanced to ensure that the composite material maintains a compressive strength suitable for structural applications, such as in residential housing or urban infrastructure. Through the use of specific weight percentages and interfacial bonding agents, the material achieves a reduction in thermal conductivity and an increase in specific heat capacity without the structural degradation typically associated with non-traditional fillers. This allows the built environment to transition from a passive shelter to a “smart space” that responds to external stressors, thereby mitigating the physical and psychological discomfort of the occupants.

Furthermore, the smart construction material provides a sustainable solution by incorporating waste-sequestered components and carbon-sequestering minerals. This dual-action approach not only addresses the immediate sensory and thermal needs of the built environment but also reduces the long-term carbon footprint of the construction process. The following figures and descriptions illustrate the specific compositions, performance metrics, and manufacturing methods that enable this class of health-responsive structural elements.

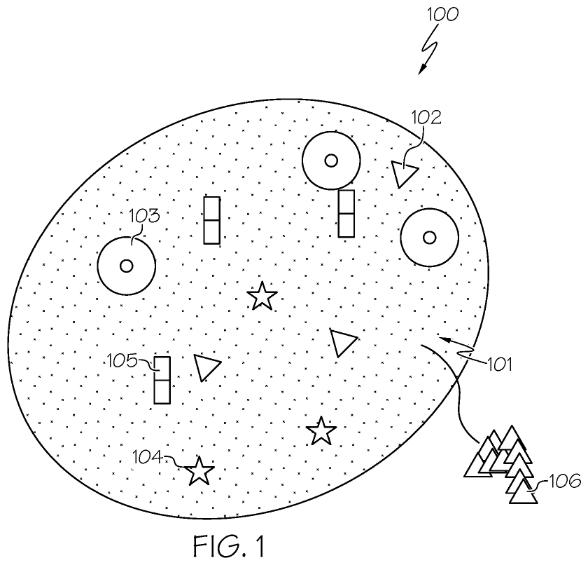

Referring now to the Figures in detail, FIG. 1 illustrates an embodiment of the present disclosure of a smart construction material 100 shown in a cured, cross-sectional state. As illustrated, smart construction material 100 includes a cementitious binder 101 and a plurality of aggregates 102 forming a structural matrix. In one embodiment, cementitious binder 101 contains Portland cement, while aggregates 102 contain sand or other fine-to-coarse mineral fillers.

In one embodiment, integrated throughout the structural matrix is a plurality of bioinspired additives configured to provide ambient modification of a built environment. In the illustrated embodiment, these additives include a thermal-regulation additive 103 (also referred to herein as the “thermally-active component”) and a sensory-enhancement additive 104 (also referred to herein as the “sensory-active component”). In one embodiment, thermal-regulation additive 103 contains a phase change material (PCM) encapsulated within a polymer shell, configured to absorb or release thermal energy to regulate the temperature of the material.

In one embodiment, sensory-enhancement additive 104 is shown as a distributed network of components, which may include bioluminescent pigments configured to emit light in low-ambient conditions, or photochromic materials that change color in response to ultraviolet radiation.

Furthermore, the structural matrix may include nacre-inspired structures 105, such as chitosan or calcium carbonate formations, arranged in a “brick-and-mortar” architecture to enhance the fracture toughness and overall durability of the material without significantly reducing its compressive strength.

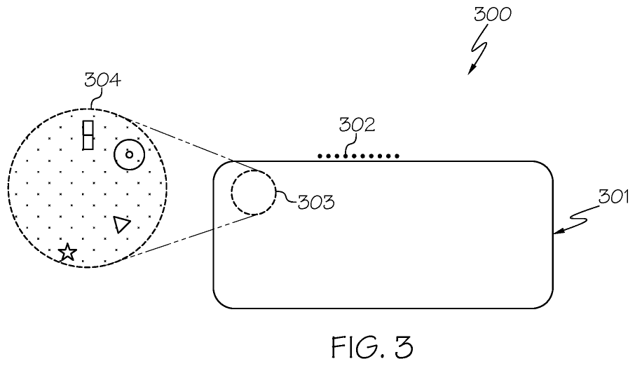

In one embodiment, the plurality of bioinspired additives contain chitosan or nacre-inspired calcium carbonate structures to enhance fracture toughness. Specifically, the chitosan may be incorporated as a biopolymer coating or fibrous reinforcement that forms a sacrificial bond network within cementitious binder 101, whereas, the nacre-inspired calcium carbonate structures (e.g., nacre-inspired structural reinforcements 105) provide a “brick-and-mortar” architecture. The synergy between the organic chitosan and the inorganic calcium carbonate structures mimics the toughening mechanisms found in biological shells, allowing structural element 300 (discussed later herein in connection with FIG. 3) to undergo significant deformation and energy absorption without catastrophic failure.

In one embodiment, the plurality of bioinspired additives includes a thermal barrier additive configured to increase a thermal resistance (R-value) of the structural element 300 (discussed further below in connection with FIG. 3). This thermal barrier additive may include aerogel particles, vacuum-insulated microspheres, or low-conductivity glass bubbles that create a thermal discontinuity within cementitious binder 101, thereby inhibiting heat transfer via conduction. In one embodiment, the plurality of bioinspired additives further includes a bio-mimetic additive configured to improve an acoustic damping of structural element 300. The bio-mimetic additive may be modeled after the cellular structure of wood or the hierarchical porosity of bone, containing an elastomeric or polymeric phase that serves to dissipate mechanical vibration into heat, thereby reducing the acoustic transmission through structural element 300 and enhancing the auditory comfort of the built environment.

In one embodiment, the plurality of bioinspired additives (or smart additives) includes a bio-mimetic additive configured to improve an acoustic damping of structural element 300 (discussed further below in connection with FIG. 3), where the bio-mimetic additive includes a micro-encapsulated healing agent configured to repair micro-cracks within the cured cementitious matrix. The micro-encapsulated healing agent may include an epoxy, polyurethane, or mineral-based core that is released upon the formation of a crack to autogenously seal the matrix and restore structural integrity. In another embodiment, the smart additives further includes a thermochromic material that modulates a solar reflectance of the structural element (e.g., structural element 300 of FIG. 3) based on surface temperature. This thermochromic material allows the structural element (e.g., structural element 300 of FIG. 3) to dynamically adjust its albedo, increasing reflectance during high-temperature periods to reduce urban heat island effects and decreasing reflectance during cooler periods to facilitate passive solar heating. Additionally, as previously described, thermal-regulation additive 103 may serve as a thermal barrier additive, where the thermal barrier additive contains aerogel particles or vacuum-insulated microspheres configured to increase a thermal resistance (R-value) of the structural element (e.g., structural element 300).

In one embodiment, the volume fraction of these additives can be adjusted to achieve specific performance targets. For example, the inclusion of a waste-sequestered component 106, such as recycled glass cullet or fly ash, may be integrated into cementitious binder 101 to reduce the carbon footprint of the material while maintaining the structural standards required for civil engineering applications.

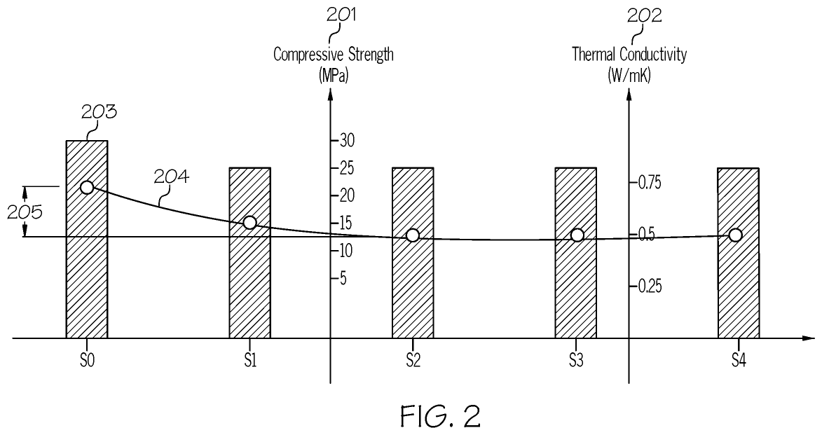

FIG. 2 provides a graphical representation of the mechanical and thermal performance characteristics of the smart construction material across a plurality of samples (S0, S1, S2, S3, S4) in accordance with an embodiment of the present disclosure.

As illustrated in FIG. 2, the graph utilizes a dual-axis plot to compare the compressive strength 201 (measured in MPa) against the thermal conductivity 202 (measured in W/mK).

As shown in FIG. 2, compressive strength 201 is represented by a series of vertical bars 203. For the control sample S0, which contains a standard mortar mixture without bioinspired additives, the compressive strength is approximately 28.5 MPa. For the enhanced samples S1-S4, which incorporate varying volume fractions of the thermal-regulation and sensory-enhancement additives, the compressive strength remains substantially maintained at or approximately above a structural threshold of 25 MPa. This visual data confirms that the integration of the distributed network of additives does not result in the structural degradation typically associated with non-traditional fillers in cementitious matrices.

Simultaneously, thermal conductivity 202 is represented by a data line 204 plotted across the samples. While the baseline sample S0 exhibits a thermal conductivity of approximately 0.65 W/mK, the smart construction material samples S1-S4 demonstrate a significant reduction in heat transfer. As indicated by the downward slope of the data line 204, the thermal conductivity is reduced to a range between approximately 0.48 W/mK and 0.55 W/mK.

This represents a thermal conductivity reduction 205 of at least 15% relative to the standard mortar mixture S0, effectively validating the thermal-regulation capabilities of the material. The synergistic relationship illustrated in FIG. 2 demonstrates that the smart construction material achieves superior insulation properties while simultaneously satisfying the load-bearing requirements for structural elements in a built environment.

Referring now to FIG. 3, FIG. 3 illustrates a perspective view of a structural element 300 containing the smart construction material 100 of FIG. 1 in accordance with an embodiment of the present disclosure.

As shown in FIG. 3, structural element 300 is depicted as a masonry unit or pre-cast building block, though it will be understood that the element may also take the form of a wall panel, flooring tile, or other load-bearing component.

In one embodiment, structural element 300 is a pre-cast wall panel or a masonry unit. As a pre-cast wall panel or masonry unit, structural element 300 includes a structural body 301 and a health-responsive surface 302. In one embodiment, structural element 300 is configured for modular assembly within an urban infrastructure to provide both load-bearing capacity and ambient modification of the built environment.

In one embodiment, structural body 301 constitutes the bulk volume of structural element 300 and is formed from the cured cementitious matrix described in FIG. 1. This body provides the primary mechanical support for the element, maintaining a compressive strength above 25 MPa to ensure structural stability within a building frame.

In one embodiment, health-responsive surface 302 represents the outward-facing interface of structural element 300 that interacts with the inhabitants of a built environment. In some embodiments, health-responsive surface 302 is treated or embedded with a higher concentration of sensory-enhancement additives 104 (from FIG. 1) to provide tactile textures or visual feedback, such as bioluminescence or photochromic color shifts, which assist in mitigating the psychological distress associated with urban density.

In one embodiment, sensory-enhancement additive 104 corresponds to a sound-absorbing porous aggregate. The sound-absorbing porous aggregate may include expanded perlite, exfoliated vermiculite, or porous volcanic scoria having a multi-scale pore structure configured to dissipate acoustic energy through visco-inertial losses within the pores. By integrating this sound-absorbing porous aggregate as a component of the sensory-active network, structural element 300 is enabled to regulate the acoustic environment of a built space, further mitigating psychological distress by reducing ambient noise levels and reverberation.

As further illustrated in FIG. 3, a magnified detail view 304 is provided, corresponding to the callout region 303 of structural body 301. This magnified detail view 304 visually confirms the internal morphology of the material, showing a distributed network of smart additives integrated within the matrix. These additives include the thermal-regulation additives 103 (circles), sensory-active pigments 104 (stars), and nacre-inspired structural reinforcements 105 (bricks) previously described. By distributing this network throughout structural body 301, structural element 300 functions as a proactive environmental regulator, reducing thermal transfer and enhancing the acoustic and visual comfort of the interior space.

In one embodiment, thermally-active component 103 contains expanded perlite or vermiculite, which provides a low-density, porous structure that enhances the thermal resistance of the matrix. Furthermore, in one embodiment, sensory-active component 104 contains a tactile-enhancing agent configured to modify a surface texture of the cured structural component 300. This tactile-enhancing agent may include micro-textured polymeric beads, textured fibers, or mineral particulates that create health-responsive surface 302 with specific roughness profiles to provide sensory feedback to an occupant. To ensure the structural integrity of the composite, the plurality of bioinspired additives (e.g., elements 103, 104) are treated with a silane coupling agent prior to incorporation into the dry mix to improve interfacial bonding with cementitious binder 101. The silane coupling agent acts as a molecular bridge between the inorganic cementitious binder 101 and the functional surfaces of the additives, thereby preventing debonding and ensuring the mechanical load is effectively transferred across the material interface.

In one embodiment, the magnified view 304 clarifies the hierarchical arrangement of the additives, where the bioinspired additives contain chitosan or nacre-inspired calcium carbonate structures to enhance fracture toughness. In this embodiment, the chitosan acts as a compliant interface between the rigid cementitious binder 101 and the nacre-inspired structural reinforcements 105, facilitating a “sliding” mechanism under stress that arrests micro-crack propagation. By including these specific bioinspired components, structural element 300 is enabled to maintain high mechanical performance and structural integrity even when high concentrations of sensory-active or thermally-active additives are present.

In one embodiment, the magnified view 304 demonstrates the spatial distribution of the additives, where the distributed network includes a thermal barrier additive configured to increase a thermal resistance (R-value) of structural element 300 and a bio-mimetic additive configured to improve an acoustic damping of structural element 300. The thermal barrier additive and the bio-mimetic additive are strategically positioned within the “brick-and-mortar” architecture to interrupt both thermal and acoustic pathways, ensuring that structural element 300 functions as a multi-functional shield against external environmental stressors.

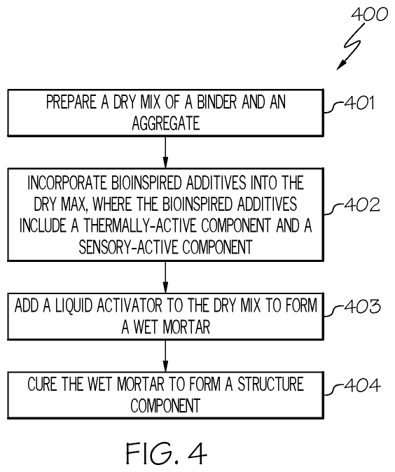

While FIG. 3 illustrates the integrated functionality of the smart construction material within a finished structural element 300, the specialized properties of the material are dependent upon a precise sequence of additive integration and environmental curing. To ensure the uniform distribution of the network of smart additives shown in the magnified view 304, a specific manufacturing methodology is employed to balance the chemical activation of the binder with the preservation of the bioinspired components as discussed below in connection with FIG. 4.

FIG. 4 is a flowchart of a method 400 for producing the smart construction material in accordance with an embodiment of the present disclosure.

Referring to FIG. 4, in conjunction with FIGS. 1-3, in step 401, a dry mix of a binder (e.g., cementitious binder 101) and an aggregate (e.g., aggregate 102) is prepared. In one embodiment, aggregate 102 consists of a combination of structural mineral sand and the sound-absorbing porous aggregate associated with sensory-enhancement additive 104.

In one embodiment, a dry mix of a binder (e.g., cementitious binder 101) and an aggregate (e.g., aggregate 102) is prepared by measuring the binder (e.g., cementitious binder 101) and aggregate (e.g., aggregate 102) according to a predetermined mass ratio and combined in a high-shear or planetary mixer to ensure a homogenous distribution of particles. In one embodiment, the mixing duration and intensity in step 401 are selectively controlled to ensure the sound-absorbing porous aggregate is evenly distributed without crushing the delicate pore structures required for acoustic attenuation. In one embodiment, the binder (e.g., cementitious binder 101) contains Portland cement and the aggregate (e.g., aggregate 102) contains graded mineral sand, which are mixed for a duration sufficient to eliminate clumps and achieve a uniform gray-scale consistency.

In one embodiment, the binder and aggregate materials are selected in such a manner in order to provide the necessary nucleation sites for subsequent additive integration. By establishing this dry matrix first, the method ensures that waste-sequestered components 106 or carbon-sequestering minerals can be evenly dispersed before the introduction of liquid activators. This mechanical preparation enables the achievement of the final structural threshold of 25 MPa, as it prevents the formation of voids or weak zones within the cured cementitious matrix.

In step 402, bioinspired additives (e.g., thermal-regulation additive 103 and sensory-enhancement additive 104) are incorporated into the dry mix, where the bioinspired additives include a thermally-active component (e.g., thermal-regulation additive 103) and a sensory-active component (e.g., sensory-enhancement additive 104).

In one embodiment, the bioinspired additives are incorporated into the dry mix by gradually introducing the additives into the mixer while maintaining a lower shear speed to prevent the mechanical rupture of the encapsulated phase change materials (e.g., thermal-regulation additive 103) or the degradation of the bioluminescent pigments (e.g., sensory-enhancement additive 104). This sequential integration ensures that the additives form the distributed network illustrated in the magnified view 304 of FIG. 3. By dispersing these components in the dry state, the method facilitates a uniform interfacial bond between the additives (e.g., elements 103-104) and the cementitious binder (e.g., cementitious binder 101) once the liquid activator is introduced.

In one embodiment, the plurality of bioinspired additives are treated with a silane coupling agent prior to incorporation into the dry mix to improve interfacial bonding with the binder. This pre-treatment involves coating the expanded perlite, vermiculite, or tactile-enhancing agents with a functional silane solution, which modifies the surface energy of the additives to be more compatible with the hydrophilic environment of cementitious binder 101. By establishing this enhanced interfacial bond, the method facilitates the uniform distribution of the network while simultaneously contributing to the final compressive strength exceeding 3000 psi.

In one embodiment, such an incorporation of the bioinspired additives into the dry mix enables the “ambient modification” capabilities of the final structural element. The precise dispersion of the thermally-active components during this stage is what allows the material to achieve the 15% reduction in thermal conductivity and the increased specific heat capacity shown in the empirical data.

In step 403, a liquid activator is added to the dry mix to form a wet mortar. A liquid activator, as used herein, refers to a fluid medium, typically aqueous-based, that initiates a chemical hydration or geopolymerization reaction within a cementitious binder (e.g., cementitious binder 101) to facilitate the transition from a dry particulate state to a cohesive, hardened matrix. A wet mortar, as used herein, refers to a plastic, workable composite of binder, aggregates, and additives in a pre-cured state, characterized by a specific flowability that allows it to be cast, molded, or extruded into a desired geometry.

In one embodiment, the liquid activator primarily consists of water, but may further include chemical admixtures, such as superplasticizers or accelerators, to manage the workability and setting time of the mixture.

In one embodiment, the liquid activator is water or an aqueous alkaline solution. In this embodiment, the incorporation of the plurality of bioinspired additives (e.g., elements 103, 104) involves adding a carbon-sequestering mineral that reacts with CO₂ during the subsequent curing of the wet mortar. The carbon-sequestering mineral may include magnesium silicate, calcium oxide, or olivine-based particulates that are distributed within the wet mortar to serve as nucleation sites for carbonation. By integrating these minerals during the wet-mix stage, the method ensures that the resulting structural element 300 acts as a carbon sink, actively capturing atmospheric carbon dioxide as the cementitious matrix stabilizes.

In one embodiment, the liquid activator is added to the dry mix to form a wet mortar by introducing the liquid activator at a controlled rate while continuing the mixing process. This ensures that cementitious binder 101 fully hydrates and encapsulates aggregates 102 and bioinspired additives 103, 104. The ratio of liquid activator to dry mix is carefully maintained to ensure the resulting wet mortar achieves the “flow” characteristics illustrated in the empirical data, which enables the subsequent molding of structural elements.

In one embodiment, there is a prior uniform dispersion of additives in the dry state, which prevents “clumping” or uneven hydration once the liquid is introduced. By preventing clumping or uneven hydration once the liquid is introduced, the distributed network of additives is ensured of remaining stable and functional throughout the volume of the material.

In step 404, the wet mortar is cured to form a structural element (e.g., structural element 300).

In one embodiment, the curing process involves placing the wet mortar into a mold or formwork defining the geometry of the structural body 301 and allowing the cementitious matrix to undergo a controlled hydration reaction. In one embodiment, during this stage, the incorporation of the plurality of bioinspired additives involves adding a carbon-sequestering mineral that reacts with CO₂ during the curing of the wet mortar. Specifically, as the mortar cures, the carbon-sequestering mineral undergoes a mineralization reaction, converting absorbed CO₂ into stable solid carbonates (e.g., calcium carbonate) within the pore structure of structural element 300. This reaction not only reduces the carbon footprint of the construction process but also densifies the internal morphology, contributing to a compressive strength exceeding 3000 psi and enhancing the overall durability of the built environment.

In one embodiment, the curing in step 404 is performed under specific environmental conditions, such as a controlled humidity of at least 90% and a temperature range of approximately 20° C. to 25° C., for a duration of at least 28 days. This controlled environment ensures that cementitious binder 101 achieves a high degree of polymerization around the distributed network of bioinspired additives 103, 104, thereby maximizing the interfacial bond strength.

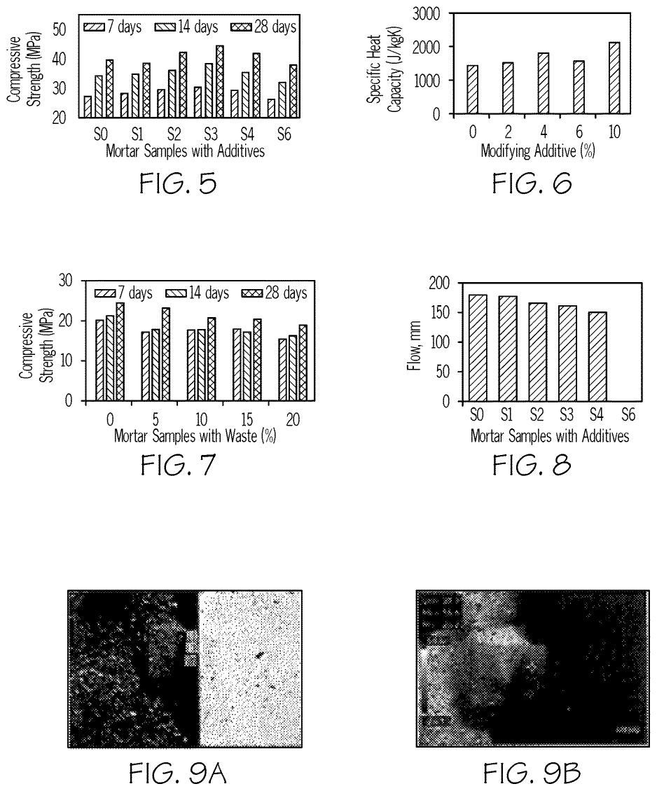

In one embodiment, the wet mortar is cured to form a structural element (e.g., structural element 300) as shown by the specific curing curves illustrated in the empirical data of FIG. 5 (where FIG. 5 illustrates the strength development over time and FIG. 2 illustrates the final stabilized strength relative to thermal conductivity), which demonstrate that the compressive strength 201 increases over time (e.g., at 7, 14, and 28 days).

Referring now to FIG. 5, FIG. 5 illustrates the compressive strength (MPa) versus mortar samples with additives in accordance with an embodiment of the present disclosure.

By following the curing protocol discussed above, structural element 300 is guaranteed to surpass the structural threshold of 25 MPa while maintaining the thermal conductivity reduction 205 of at least 15%. In one embodiment, structural element 300 (or structural component) is characterized by a compressive strength exceeding 3000 psi. As demonstrated by the empirical data in FIG. 5, the transition from the wet mortar state to the cured structural element 300 results in a dense, hybridized matrix where the bioinspired additives 103, 104 are chemically and mechanically locked in place, ensuring that the 3000 psi threshold is met or exceeded by the 28-day curing mark while simultaneously providing the aforementioned ambient modification features.

Referring now to FIG. 6, FIG. 6 illustrates the specific heat capacity versus additive percentage in accordance with an embodiment of the present disclosure.

As shown in FIG. 6, FIG. 6 illustrates the relationship between the concentration of the bioinspired modifying additives and the material's thermal storage capacity. Furthermore, as shown in FIG. 6, the specific heat capacity (J/kgK) increases from approximately 1400 J/kgK in the control sample (0%) to over 2100 J/kgK when the additive concentration reaches 10%.

Referring now to FIG. 7, FIG. 7 illustrates the compressive strength versus waste percentage in accordance with an embodiment of the present disclosure.

As shown in FIG. 7, FIG. 7 demonstrates the impact of integrating waste-sequestered components 106 (such as recycled glass or fly ash) on the mechanical integrity of the mortar. The plot of FIG. 7 confirms that even with a waste replacement level of up to 20%, the material maintains a substantial percentage of its compressive strength, supporting the sustainability goals of the disclosure.

Referring now to FIG. 8, FIG. 8 illustrates workability and flow metrics in accordance with an embodiment of the present disclosure.

As shown in FIG. 8, FIG. 8 illustrates the flow (mm) characteristics of different mortar samples (S0-S6) containing the distributed network of additives. The data indicates that while additives slightly reduce flow, the material remains within a workable range (approx. 150-180 mm), ensuring it can be cast into structural element 300.

Referring now to FIGS. 9A-9B, FIGS. 9A-9B provide a side-by-side comparison of an optical picture and a thermal picture of the smart construction material in a real-world field pilot application, respectively, in accordance with an embodiment of the present disclosure.

As illustrated in FIGS. 9A-9B, the thermal imaging visually confirms the temperature differential between the smart material and conventional surroundings, illustrating reduced heat absorption.

The present disclosure provides a smart construction material and a method for producing the same that integrates bioinspired engineering with structural civil applications. By utilizing a distributed network of thermally-active and sensory-active additives within a cementitious matrix, the material functions as a proactive environmental regulator. As demonstrated by the empirical data in FIGS. 2 and 5-8, the material achieves a unique balance of mechanical durability and ambient modification, maintaining a structural threshold of at least 25 MPa while providing significant improvements in thermal storage and reduced heat transfer.

The benefits of the smart construction material described herein are manifold. First, the inclusion of thermal-regulation additives 103 provides a sustainable solution for climate control in the built environment. By reducing thermal conductivity by at least 15% and increasing specific heat capacity, the material minimizes the energy required for mechanical heating and cooling, thereby reducing the carbon footprint of the building. Second, sensory-enhancement additives 104 provide extra-sensory features, such as bioluminescence and color adaptation, which improve the physical and mental comfort of occupants by mitigating the psychological distress often associated with urban overcrowding and extreme weather.

Furthermore, the integration of waste-sequestered components 106 and nacre-inspired structures 105 ensures that the material is both environmentally responsible and structurally resilient. The ability to repurpose waste materials without compromising the 28-day compressive strength allows for the creation of “carbon-sequestering” infrastructure that meets modern sustainability standards. Ultimately, the structural elements and methods disclosed herein transform passive building components into active participants in human wellness and environmental stewardship.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A smart construction material for ambient modification of a built environment,
comprising
a base mortar mixture comprising a binder and an aggregate; and
a plurality of bioinspired additives integrated into said base mortar mixture, wherein said plurality of bioinspired additives comprises a thermal-regulation additive and a sensory-enhancement additive, wherein said smart construction material is configured to maintain a compressive strength of approximately 25 MPa while providing a reduction in thermal conductivity compared to a standard mortar mixture.

2. The smart construction material as recited in claim 1, wherein said binder comprises Portland cement and said aggregate comprises sand.

3. The smart construction material as recited in claim 1, wherein said thermal-regulation additive comprises a phase change material (PCM) encapsulated within a polymer shell.

4. The smart construction material as recited in claim 1, wherein said plurality of bioinspired additives further comprises a waste-sequestered component comprising recycled glass cullet or fly ash.

5. The smart construction material as recited in claim 1, wherein said sensory-enhancement additive comprises a bioluminescent pigment configured to emit light in response to low-ambient light conditions.

6. The smart construction material as recited in claim 1, wherein said sensory-enhancement additive comprises a sound-absorbing porous aggregate.

7. The smart construction material as recited in claim 1, wherein said plurality of bioinspired additives comprises chitosan or nacre-inspired calcium carbonate structures to enhance fracture toughness.

8. The smart construction material as recited in claim 1, wherein said thermal conductivity is reduced by at least 15% relative to said standard mortar mixture.

9. The smart construction material as recited in claim 1, wherein said smart construction material further comprises a photochromic additive configured to change color in response to ultraviolet (UV) radiation.

10. A method for manufacturing a smart construction material, the method comprising:
preparing a dry mix of a binder and an aggregate;
incorporating a plurality of bioinspired additives into said dry mix, wherein said bioinspired additives include a thermally-active component and a sensory-active component;
adding a liquid activator to said dry mix to form a wet mortar; and
curing said wet mortar to form a structural component, wherein said structural component is characterized by a compressive strength exceeding 3000 psi.

11. The method as recited in claim 10, wherein said thermally-active component comprises expanded perlite or vermiculite.

12. The method as recited in claim 10, wherein said sensory-active component comprises a tactile-enhancing agent configured to modify a surface texture of said cured structural component.

13. The method as recited in claim 10, wherein said plurality of bioinspired additives are treated with a silane coupling agent prior to incorporation into said dry mix to improve interfacial bonding with said binder.

14. The method as recited in claim 10, wherein said liquid activator comprises water and a superplasticizer.

15. The method as recited in claim 10, wherein said incorporating of said plurality of bioinspired additives comprises adding a carbon-sequestering mineral that reacts with CO₂ during said curing of said wet mortar.

16. A structural element for use in a health-responsive built environment, the structural element comprising:
a cured cementitious matrix; and
a distributed network of smart additives within said cured cementitious matrix, wherein said smart additives comprise:
a thermal barrier additive configured to increase a thermal resistance (R-value) of said structural element; and
a bio-mimetic additive configured to improve an acoustic damping of said structural element.

17. The structural element as recited in claim 16, wherein said structural element is a pre-cast wall panel or a masonry unit.

18. The structural element as recited in claim 16, wherein said bio-mimetic additive comprises a micro-encapsulated healing agent configured to repair micro-cracks within said cured cementitious matrix.

19. The structural element as recited in claim 16, wherein said smart additives further comprise a thermochromic material that modulates a solar reflectance of said structural element based on surface temperature.

20. The structural element as recited in claim 16, wherein said thermal barrier additive comprises aerogel particles or vacuum-insulated microspheres.
